(19) United States
(12) Patent Application Publication
(10) Pub. No.: US 2026/0187446 A1
(43) Pub. Date: Jul. 2, 2026

(54) METHOD AND APPARATUS FOR TRAINING DIFFUSION-BASED DENOISING ARTIFICIAL INTELLIGENCE MODEL AND DENOISING METHOD USING ARTIFICIAL INTELLIGENCE MODEL

(71) Applicant: ELECTRONICS AND TELECOMMUNICATIONS RESEARCH INSTITUTE, Daejeon (KR)

(72) Inventors: Hyung Wook Noh, Daejeon (KR); Youngwoong Han, Daejeon (KR); Seohee So, Daejeon (KR); Myung-eun Lim, Daejeon (KR); Ho-Youl Jung, Daejeon (KR)

(21) Appl. No.: 19/279,411

(22) Filed: Jul. 24, 2025

(30) Foreign Application Priority Data
Dec. 26, 2024 (KR) 10-2024-0197542

(51) Int. Cl. G06N 3/08

(52) U.S. Cl. CPC G06N 3/08

(57) ABSTRACT

A method and apparatus for training a diffusion-based denoising artificial intelligence (AI) model and a denoising method using the AI model are provided. The method of training the diffusion-based denoising AI model includes determining first training data and clean data of a training data set, estimating noise data by inputting, to the denoising AI model, a training data set and a first sampling level indicating a number of sampling steps to be applied to the training data, based on a difference between first ground truth data and noise data, determining a loss value, and based on the loss value, training the denoising AI model.

### CROSS-REFERENCE TO RELATED APPLICATION

This application claims the benefit of Korean Patent Application No. 10-2024-0197542, filed on Dec. 26, 2024, in the Korean Intellectual Property Office, the entire disclosure of which is incorporated herein by reference for all purposes.

### BACKGROUND

### 1. Field of the Invention

One or more embodiments relate to a method and apparatus for training a diffusion-based denoising artificial intelligence (AI) model and a denoising method using the AI model.

### 2. Description of the Related Art

A deep learning-based denoising diffusion probabilistic model (DDPM) is a type of probabilistic generative model. The diffusion model may add noise to data using Gaussian noise in a forward process. The diffusion model may restore data by removing noise in a reverse process. The diffusion model may be trained to perform the reverse process. The diffusion model may be used to perform denoising on data including noise in various fields. For example, the diffusion model may be used to perform denoising on biomedical signal data in the medical technology field.

### SUMMARY

Embodiments provide a diffusion model that may be trained with data generated using Gaussian noise in a forward pass. Accordingly, the diffusion model may exhibit degraded denoising performance for actual data including non-Gaussian noise.

According to an aspect, there is provided a method of training a diffusion-based denoising artificial intelligence (AI) model, the method including determining first training data and clean data of a training data set. estimating noise data by inputting, to the denoising AI model, the training data set and a first sampling level indicating a number of sampling steps to be applied to the first training data. based on a difference between first ground truth data and the noise data, determining a loss value, wherein the first ground truth data corresponds to a difference between the first training data and the clean data, and based on the loss value, training the denoising AI model.

According to another aspect, there is provided a denoising method including training a diffusion-based denoising AI model, receiving first data and a first signal-to-noise ratio (SNR) value of the first data, based on the first SNR value, determining a first sampling level indicating a number of sampling steps to be applied to the first data, and generating first restored data by inputting, to the trained denoising AI model, the first data and the first sampling level, and wherein the training of the denoising AI model may include determining first training data and clean data of a training data set, estimating noise data by inputting, to the denoising AI model, the training data set and a second sampling level indicating a number of sampling steps to be applied to the first training data, based on a difference between first ground truth data and the noise data, determining a loss value, wherein the first ground truth data corresponds to a difference between the first training data and the clean data, and based on the loss value, training the denoising AI model.

According to another aspect, there is provided an apparatus for training a diffusion-based denoising AI model, the apparatus including one or more processors and a memory comprising instructions executable by the one or more processors, wherein the instructions, when executed by the one or more processors, may cause the apparatus to determine first training data and clean data of a training data set, estimate noise data by inputting, to the denoising AI model, the training data set and a first sampling level indicating a number of sampling steps to be applied to the first training data, based on a difference between first ground truth data and the noise data, determine a loss value, wherein the first ground truth data corresponds to a difference between the first training data and the clean data, and based on the loss value, train the denoising AI model.

Additional aspects of embodiments will be set forth in part in the description which follows and, in part, will be apparent from the description, or may be learned by practice of the disclosure.

According to embodiments, a diffusion model may exhibit good denoising performance for actual data including non-Gaussian noise.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an example of a process of training a typical diffusion artificial intelligence (AI) model;

FIG. 2 is a flowchart of a method of training a diffusion-based denoising AI model using data including non-Gaussian noise, according to an embodiment;

FIG. 3 is a diagram illustrating an example of a process of training a diffusion-based denoising AI model using training data, which is non-Gaussian noise, according to an embodiment;

FIG. 4 is a diagram illustrating an example of a process of training a diffusion-based denoising AI model using training data mixed with Gaussian noise, according to an embodiment;

FIG. 5 is a flowchart of a denoising method using a trained diffusion-based denoising AI model, according to an embodiment;

FIG. 6 is a flowchart of a method of training a diffusion-based denoising AI model, according to an embodiment;

FIG. 7 is a block diagram illustrating a configuration of a denoising apparatus, according to an embodiment;

FIG. 8 is a block diagram illustrating a configuration of a training apparatus, according to an embodiment; and

FIG. 9 is a block diagram illustrating a configuration of an electronic apparatus for performing denoising, according to an embodiment.

### DETAILED DESCRIPTION

The following structural or functional descriptions of embodiments are provided as examples only, and various alterations and modifications may be made to the embodiments. Accordingly, the embodiments are not construed as limited to the disclosure and should be understood to include all changes, equivalents, and replacements within the idea and the technical scope of the disclosure.

Although terms, such as “first”, “second”, and the like, may be used herein to describe various components, these terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms used herein including technical or scientific terms have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments are described in detail with reference to the accompanying drawings. When describing the embodiments with reference to the accompanying drawings, like reference numerals refer to like elements and a repeated description related thereto will be omitted.

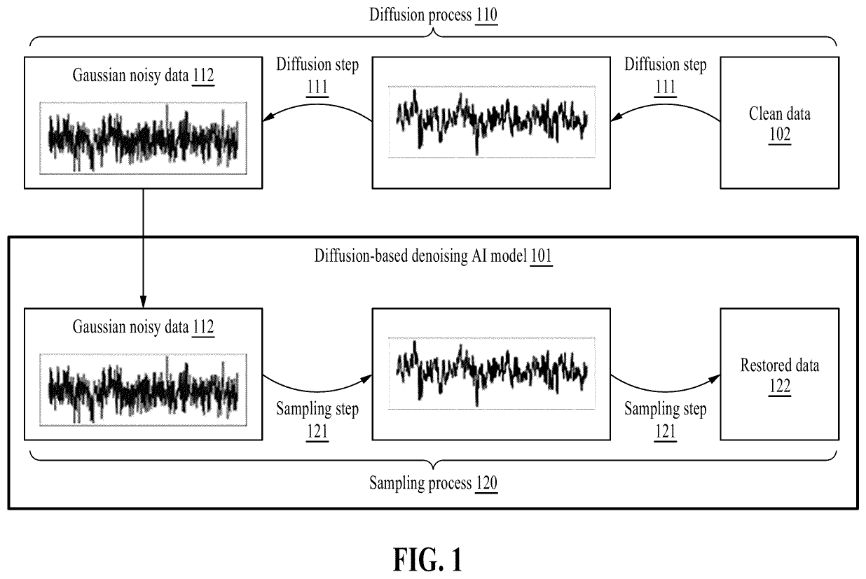

FIG. 1 is a diagram illustrating an example of a process of training a typical diffusion artificial intelligence (AI) model. Referring to FIG. 1, a diffusion-based denoising AI model 101 may be trained using clean data 102 through a forward process and a reverse process. The clean data 102 may be data that does not include noise. The forward process may correspond to a diffusion process 110. The reverse process may correspond to a sampling process 120.

The diffusion process 110 may be a process of gradually adding noise to the clean data 102. The diffusion process 110 may include one or more time steps for adding noise. A diffusion step 111 may correspond to a time step at which noise addition to data is performed once. Although FIG. 1 illustrates that the diffusion process 110 includes two diffusion steps 111, the number of diffusion steps 111 included in the diffusion process 110 is not limited thereto. For example, the diffusion process 110 may include 1,000 diffusion steps 111.

In the diffusion process 110, one or more diffusion steps 111 may be applied to the clean data 102. At each diffusion step 111, noise may be added to the clean data 102, so the clean data 102 may be contaminated with the noise. At each diffusion step 111, the noise added to the clean data 102 may be Gaussian noise. Through the diffusion process 110, the clean data 102 may be contaminated with the Gaussian noise. The more diffusion steps 111 the diffusion process 110 includes, that is, the more diffusion steps 111 are applied to the clean data 102, the more the clean data 102 may be contaminated with the Gaussian noise. As one or more diffusion steps 111 of the diffusion process 110 are applied to the clean data 102, Gaussian noisy data 112 may be generated.

The Gaussian noisy data 112 may be used to train the diffusion-based denoising AI model 101. The diffusion-based denoising AI model 101 may be an AI model for estimating noise included in input data and removing the noise. The diffusion-based denoising AI model 101 may receive the Gaussian noisy data 112 as input data. The diffusion-based denoising AI model 101 may receive the number of diffusion steps 111 corresponding to the Gaussian noisy data 112. The diffusion-based denoising AI model 101 may estimate noise included in the Gaussian noisy data 112 and remove the noise through the sampling process 120.

The sampling process 120 may be a process of gradually removing noise from the Gaussian noisy data 112. The sampling process 120 may include one or more time steps for removing noise. A sampling step 121 may correspond to a time step at which the diffusion-based denoising AI model 101 performs denoising on data once. Although FIG. 1 illustrates that the sampling process 120 includes two sampling steps 121, the number of sampling steps 121 included in the sampling process 120 is not limited thereto. For example, the sampling process 120 may include 1,000 sampling steps 121. The number of sampling steps 121 included in the sampling process 120 may be the same as the number of diffusion steps 111 included in the diffusion process 110.

In the sampling process 120, one or more sampling steps 121 may be applied to the Gaussian noisy data 112. At each sampling step 121, noise may be estimated and removed. The diffusion-based denoising AI model 101 may generate restored data 122 through the sampling process 120. The data estimated as noise and removed in the sampling process 120 may be compared to data added in the diffusion process 110 to train the diffusion-based denoising AI model 101. When the data added in the diffusion process 110 is compared to the data estimated in the sampling process 120, the data added at each diffusion step 111 may be compared to the data estimated at the sampling step 121 corresponding to each diffusion step 111. The diffusion-based denoising AI model 101 may be trained so that the difference between the data added in the diffusion process 110 and the data estimated in the sampling process 120 is reduced.

In a typical method of training the diffusion-based denoising AI model 101, the noise added in the diffusion process 110 may not include non-Gaussian noise. The non-Gaussian noise may be noise that does not follow a Gaussian distribution. The denoising performance of the diffusion-based denoising AI model 101, which is trained with the typical training method, may be degraded when the diffusion-based denoising AI model 101 receives actual data including non-Gaussian noise.

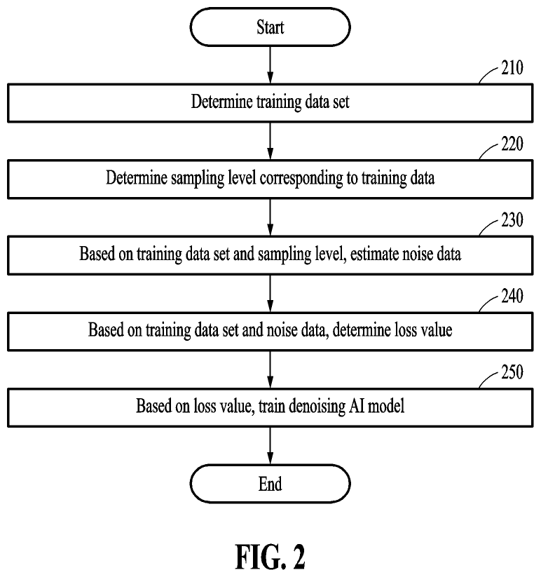

FIG. 2 is a flowchart of a method of training a diffusion-based denoising AI model using data including non-Gaussian noise, according to an embodiment. Referring to FIG. 2, in operation 210, a training data set may be determined. The training data set may include data for training a denoising AI model. The training data set may include training data and clean data. The clean data may be data obtained by removing noise from the training data. Training noise data included in the training data may correspond to the difference between the training data and the clean data. The training noise data may be data including non-Gaussian nose.

The training data may be data obtained by performing data augmentation on original data. To train the denoising AI model, first, the original data may be received. Data classification may be performed on the original data to determine the training data. The data classification may correspond to, for example, independent component analysis (ICA) or principal component analysis (PCA).

By data classification, the original data may be classified into, for example, physiological data, environmental data, instrumental data, and the like. The physiological data may include, for example, electrocardiogram (ECG), electrooculogram (EOG), and the like. The environmental data may include, for example, power line interference, electromagnetic interference (EMI), lighting inference, and the like. The instrumental data may include, for example, electrode contact noise, amplifier noise, and the like. In addition, for example, the classified data may include data corresponding to a temperature change, humidity, or movement.

The classified data set included in the original data may be referred to as a component data set. The component data set may include target component data. The target component data may correspond to data to be obtained through denoising. For example, when the original data is electroencephalogram (EEG) data including noise, the target component data may be component data corresponding to EEG. The component data set may include target noise component data. The target noise component data may be included in the training data generated through data augmentation.

When there is no clean data, the target component data may be determined as the clean data of the training data set. When there is no clean data, data obtained by combining the target component data with the target noise component data may be determined as the training data of the training data set. When there is clean data, data obtained by combining the clean data with the target noise component data may be determined as the training data of the training data set.

When the denoising AI model is trained using training data generated through data augmentation, the denoising AI model may exhibit high denoising performance on data corresponding to the target noise component data. For example, when the target component data is EEG data and the target noise component data is ECG data, the denoising AI model trained with the training data may guarantee high performance when denoising ECG noise from EEG.

In operation 220, a sampling level corresponding to the training data may be determined. The sampling level of the training data may indicate the number of sampling steps to be applied to the training data. A sampling step may correspond to the sampling step 121 of FIG. 1. The training data is not data generated through a diffusion process, so the number of sampling steps to be applied to the training data may not be determined to be the same as the number of diffusion steps applied to the clean data. When a sampling level is not determined appropriately, the denoising performance of the denoising AI model may deteriorate because less or more denoising is performed compared to the noise included in the training data. To determine the number of sampling steps to be applied to the training data, it may be determined how many times the diffusion step is applied to the clean data that the training data corresponds to.

When there is a diffusion process for generating the training data of the denoising AI model, data of the diffusion process may be represented through Equation 1 below. x₀ may be clean data. xₜ may be data with the diffusion step applied t times to the clean data. Z may be standard Gaussian noise. α̅ₜ may be a cumulative signal ratio representing the ratio of the clean data preserved while the diffusion step is applied t times. 1−α̅ₜ may be the cumulative noise ratio representing the ratio of Gaussian noise while the diffusion step is applied to the clean data t times. The cumulative signal ratio of Equation 1 may be expressed through Equation 2. αₛ may be the clean data preservation ratio of the s-th diffusion step. αₛ may be a parameter that may be set differently for each denoising AI model.

$${x}_{t} = \sqrt{{\overline{α}}_{t}} {x}_{0} + \sqrt{1 - {\overline{α}}_{t}} z \qquad [ Equation 1 ]$$

$${\overline{α}}_{t} = {\prod }_{s = 1}^{t} {α}_{s} \qquad [ Equation 2 ]$$

α̅ₜ is also used in the sampling process of the denoising AI model, so αₛ may be obtained from the denoising AI model. Therefore, when the ratio of noise included in the training data is known, it may be possible to determine how many times the diffusion step is applied to the clean data that the training data corresponds to. The sampling level of the training data may be determined based on the training data and the clean data. For example, when the ratio of the clean data to the training noise data is closest to the ratio of \sqrt{α̅ₜ} to \sqrt{1−α̅ₜ} at the 100^{th} diffusion step, it may be determined that the number of sampling steps to be applied to the training data is 100.

When there is a signal-to-noise ratio (SNR) value of the training data (for example, an SNR value received by an SNR measuring apparatus when the training data is measured), the sampling level of the training data may be determined based on the SNR value of the training data. The SNR may be defined as the ratio of power, so the SNR value of the data generated by applying the diffusion step to the clean data t times may be expressed through Equation 3. When there is the SNR value of the training data, the sampling level of the training data may be determined using Equation 3. For example, when t, which may represent the SNR value that is closest to the SNR value of the training data, is 100, it may be determined that the number of sampling steps to be applied to the training data is 100.

$$SNR = \frac{{\overline{α}}_{t}}{1 - {\overline{α}}_{t}} \qquad [ Equation 3 ]$$

In operation 230, noise data may be estimated based on the training data set and the sampling level. The noise data may be data estimated as noise included in the training data by the denoising AI model. The noise data may be estimated by inputting the training data and the sampling level to the denoising AI model. The denoising AI model may perform denoising on the training data for the number of sampling steps corresponding to the sampling level. The noise data may include data estimated as noise at each sampling step.

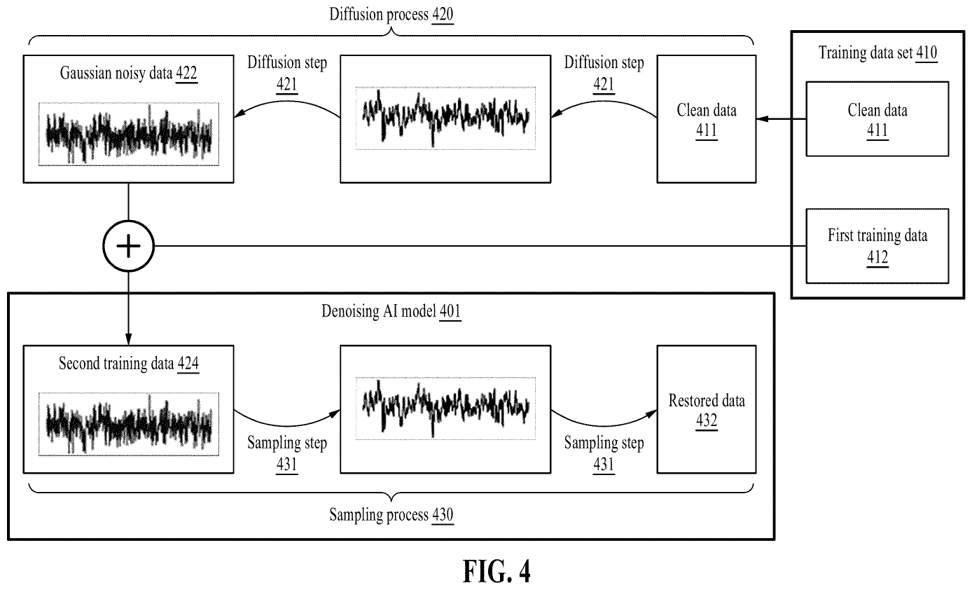

The denoising AI model may perform denoising on data including the training data and the Gaussian noisy data instead of the training data. The Gaussian noisy data may be generated based on the clean data. In this case, the noise data may be estimated by inputting the training data set and sampling level to the denoising AI model. The case in which the denoising AI model performs denoising on data including the training data and the Gaussian noisy data is described in greater detail with reference to FIG. 4.

The denoising AI model may generate restored data by removing noise data from the training data. Although not shown in FIG. 2, the restored data generated in operation 230 may be used in a recursive training process. The restored data may be contaminated with Gaussian noise through a diffusion process. The Gaussian noise generated based on the restored data may be used to train the denoising AI model through a sampling process. The diffusion process using the restored data and the sampling process using the Gaussian noisy data generated based on the restored data may correspond to the diffusion process 110 and the sampling process 120 of FIG. 1, respectively.

In operation 240, a loss value may be determined based on the training data set and the noise data. The loss data may be determined based on the difference between the ground truth data and the noise data estimated in operation 230, and the ground truth data may correspond to the difference between the training data and the clean data determined in operation 210. The ground truth data may correspond to the training noise data described with respect to operation 210. In operation 250, the denoising AI model may be trained based on the loss value. The denoising AI model may be used to restore data including noise. Compared to the denoising AI model trained using data including Gaussian noise, the denoising AI model trained based on the training data including non-Gaussian noise may perform denoising on actual data including the non-Gaussian noise more smoothly.

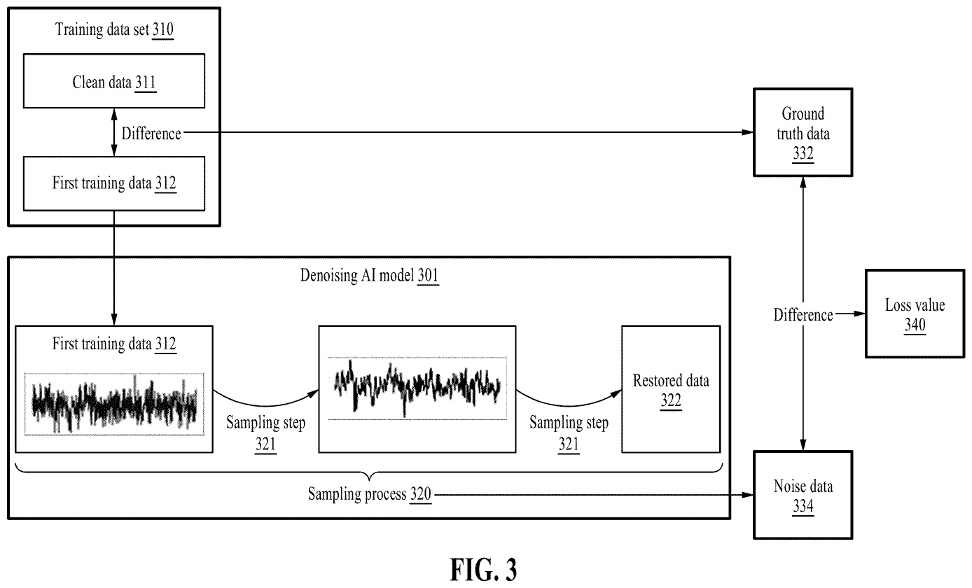

FIG. 3 is a diagram illustrating an example of a process of training a diffusion-based denoising AI model using training data, which is non-Gaussian noise, according to an embodiment. Referring to FIG. 3, a training data set 310 may include clean data 311 and first training data 312. The first training data 312 may be data including non-Gaussian noise. A denoising AI model 301 may receive the first training data 312. The denoising AI model 301 may receive a first sampling level indicating the number of sampling steps 321 to be applied to the first training data 312. The method of determining a sampling level of training data, described with reference to FIG. 2, may apply to a method of determining the first sampling level. The denoising AI model 301 may be trained based on the denoising result of the first training data 312.

Based on the first training data 312 and the first sampling level, the denoising AI model 301 may estimate noise data 334 included in the first training data 312. The denoising AI model 301 may estimate and remove noise included in the first training data 312 through a sampling process 320. The sampling process 320 may include one or more sampling steps 321. The denoising AI model 301 may generate restored data 322 obtained by removing the noise data 334 from the first training data 312 through the sampling process 320.

A loss value 340 may be determined based on the difference between the ground truth data 332 and the noise data 334. The ground truth data 332 may correspond to the difference between the clean data 311 and the first training data 312. The denoising AI model 301 may be trained based on the loss value 340. When the denoising AI model 301 is trained based on the denoising result of the first training data 312 including the actual data including the non-Gaussian noise, a training bias may occur for a predetermined number of sampling steps. In order for the denoising AI model 301 to perform stable denoising for various noise conditions, training for various numbers of sampling steps may be required.

FIG. 4 is a diagram illustrating an example of a process of training a diffusion-based denoising AI model using training data mixed with Gaussian noise, according to an embodiment. Referring to FIG. 4, a training data set 410 may include clean data 411 and first training data 412. The first training data 412 may be data including non-Gaussian noise. A denoising AI model 401 may receive the first training data 412. The denoising AI model 401 may receive a first sampling level indicating the number of sampling steps 421 to be applied to the first training data 412. The denoising AI model 401 may receive Gaussian noisy data 422. The denoising AI model 401 may be trained based on the denoising result of the combination of the first training data 412 and the Gaussian noisy data 422.

The Gaussian noisy data 422 may be generated by applying one or more diffusion steps 421 of a diffusion process 420 to the clean data 411. Gaussian noise may be added to the clean data 411 at each diffusion step 421. In the diffusion process 420, the clean data 411 may be gradually contaminated with Gaussian noise. The number of diffusion steps 421 included in the diffusion process 420 may be different from the number of sampling steps 431 included in a sampling process 430. The Gaussian noisy data 422 may be data in which the clean data 411 is contaminated with the Gaussian noise.

Second training data 424 may be generated by combining the first training data 412 with the Gaussian noisy data 422. A second sampling level corresponding to the second training data 424 may be determined based on a ratio of noise included in the first training data 412 and a ratio of Gaussian noise included in the Gaussian noisy data 422. The second sampling level may indicate the number of sampling steps to be applied to the second training data 424. The method of determining the sampling level of training data, described with reference to FIG. 2, may be applied to a method of determining the second sampling level.

The denoising AI model 401 may estimate noise data included in the second training data 424 based on the second training data 424 and the second sampling level. The denoising AI model 401 may estimate and remove noise included in the second training data 424 through the sampling process 430. The sampling process 430 may include one or more sampling steps 431. The denoising AI model 401 may generate restored data 432, which is the second training data 424 from which noise data is removed, through the sampling process 430.

A loss value may be determined based on the difference between ground truth data and the noise data 334. The ground truth data may correspond to the combination of the difference between the clean data 411 and the first training data 412 and the difference between the Gaussian noisy data 422 and the clean data 411. The denoising AI model 401 may be trained based on the loss value 340. The denoising AI model 401 trained based on the denoising result of actual data including non-Gaussian noise and the second training data 424 including Gaussian noise may perform stable denoising for various noise conditions without a training bias for a predetermined number of sampling steps.

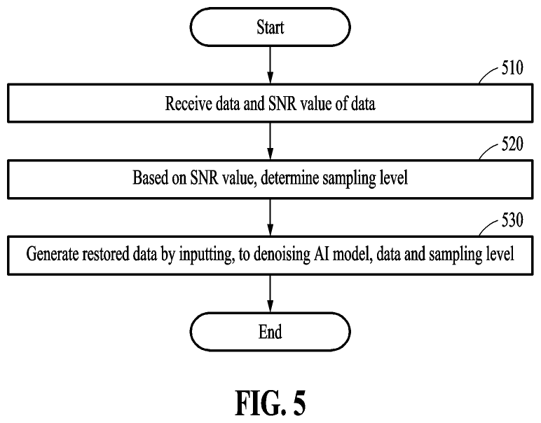

FIG. 5 is a flowchart of a denoising method using a trained diffusion-based denoising AI model, according to an embodiment. Before operation 510 is performed, a diffusion-based denoising AI model may be trained. The descriptions provided with reference to FIGS. 1 to 4 may apply to the process of training a denoising AI model.

In operation 510, a denoising apparatus may receive data and an SNR value of the data. The data may be a target of denoising by a trained denoising AI model. The data may include non-Gaussian noise. The SNR value of the data may be an SNR value measured by an SNR measuring apparatus. The SNR measuring apparatus may calculate the SNR value of the data when the data is measured. The SNR value of the data may be an SNR value calculated by an SNR extraction module. The SNR extraction module may analyze a pattern of the data and separate noise from a signal. The SNR extraction module may determine the SNR value of the data by calculating the ratio of noise to signal.

In operation 520, the denoising apparatus may determine a sampling level based on the SNR value. The method of determining the sampling level of the training data, described with reference to FIG. 2, may apply to a method of determining a sampling level of data based on the SNR value of the data.

In operation 530, the denoising apparatus may generate restored data by inputting, to the denoising AI model, data and a sampling level. The denoising AI model may perform denoising on the data based on the data and the sampling level. The denoising AI model may perform denoising on the data through a sampling process. The sampling process may include the number of sampling steps corresponding to the sampling level. The restored data may be the data from which non-Gaussian noise is removed.

Although not shown in FIG. 5, a diffusion process may be optionally applied to the restored data. The diffusion process may correspond to the diffusion process 110 of FIG. 1. Through the diffusion process, Gaussian noisy data may be generated based on the restored data. The Gaussian noisy data may correspond to the Gaussian noisy data 112 of FIG. 1. After the Gaussian noisy data is generated based on the restored data, the denoising apparatus may return to operation 520. Accordingly, denoising may be performed repeatedly and/or recursively so that a high quality denoising result may be achieved.

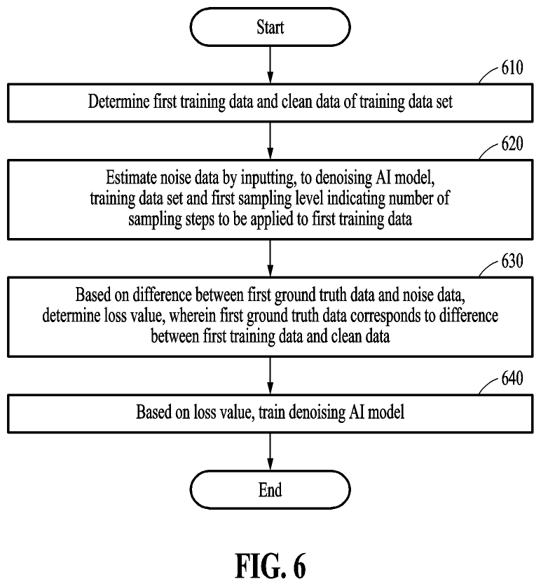

FIG. 6 is a flowchart of a method of training a diffusion-based denoising AI model, according to an embodiment. Referring to FIG. 6, in operation 610, a training apparatus may determine first training data and clean data of a training data set. The first training data may include non-Gaussian noise. The training apparatus may receive original data. The training apparatus may determine target component data and target noise component by performing data classification on the original data. The training apparatus may determine the target component data as the clean data and determine, as the first training data, a combination of the target noise component data and the target component data.

In operation 620, the training apparatus may estimate noise data by inputting, to the denoising AI model, a training data set and a first sampling level indicating the number of sampling steps to be applied to the first training data. A sampling step may correspond to a time step at which the denoising AI model performs denoising on data once. The training apparatus may generate Gaussian noisy data contaminated with Gaussian noise by applying one or more diffusion steps to the clean data. The training apparatus may generate second training data by combining the first training data with the Gaussian noisy data. The training apparatus may estimate noise data included in the second training data. The training apparatus may determine a second sampling level corresponding to the second training data. The first sampling level may be determined based on the first training data and the clean data.

In operation 630, the training apparatus may determine a loss value based on the difference between first ground truth data and the noise data, the first ground truth data corresponding to the difference between the first training data and the clean data. The training apparatus may determine the loss value based on the difference between the first ground truth data and the noise data, and the first ground truth data may correspond to the combination of the difference between the first training data and the clean data and the difference between the Gaussian noisy data and the clean data. In operation 640, the training apparatus may train the denoising AI model based on the loss value.

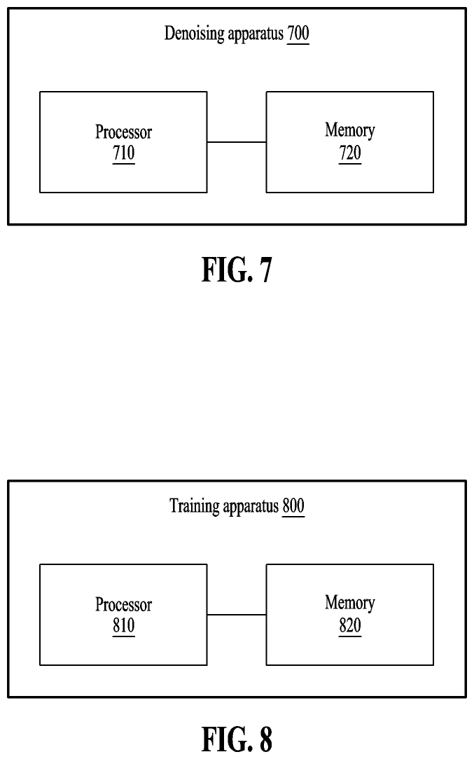

FIG. 7 is a block diagram illustrating a configuration of a denoising apparatus, according to an embodiment. Referring to FIG. 7, a denoising apparatus 700 may include a processor 710 and a memory 720. The memory 720 may be connected to the processor 710 and store instructions executable by the processor 710, data to be computed by the processor 710, or data processed by the processor 710. The memory 720 may include a non-transitory computer-readable medium (e.g., high-speed random access memory (RAM)) and/or a non-volatile computer-readable medium (e.g., one or more disk storage devices, flash memory devices, or other non-volatile solid-state memory devices).

The processor 710 may execute instructions to perform the operations described above with reference to FIGS. 1 to 6, 8, and 9. For example, the processor 710 may train a diffusion-based denoising AI model, receive first data and a first SNR value of the first data, determine, based on the first SNR value, a first sampling level indicating the number of sampling steps to be applied to the first data, and generate first restored data by inputting, to the trained denoising AI model, the first data and the first sampling level. In addition, the descriptions provided with reference to FIGS. 1 to 6, 8, and 9 may apply to the denoising apparatus 700.

FIG. 8 is a block diagram illustrating a configuration of a training apparatus, according to an embodiment. Referring to FIG. 8, a training apparatus 800 may include a processor 810 and a memory 820. The memory 820 may be connected to the processor 810 and store instructions executable by the processor 810, data to be computed by the processor 810, or data processed by the processor 810. The memory 820 may include a non-transitory computer-readable medium (e.g., high-speed RAM) and/or a non-volatile computer-readable medium (e.g., one or more disk storage devices, flash memory devices, or other non-volatile solid-state memory devices).

The processor 810 may execute instructions to perform the operations described above with reference to FIGS. 1 to 7 and 9. For example, the processor 810 may determine first training data and clean data of a training data set, estimate noise data by inputting, to a denoising AI model, the training data set and a first sampling level indicating the number of sampling steps to be applied to the first training data, determine a loss value based on the difference between first ground truth data and noise data, wherein the first ground truth data and may correspond to the difference between the first training data and the clean data, and train the denoising AI model based on the loss value. In addition, the descriptions provided with reference to FIGS. 1 to 7 and 9 may apply to the training apparatus 800.

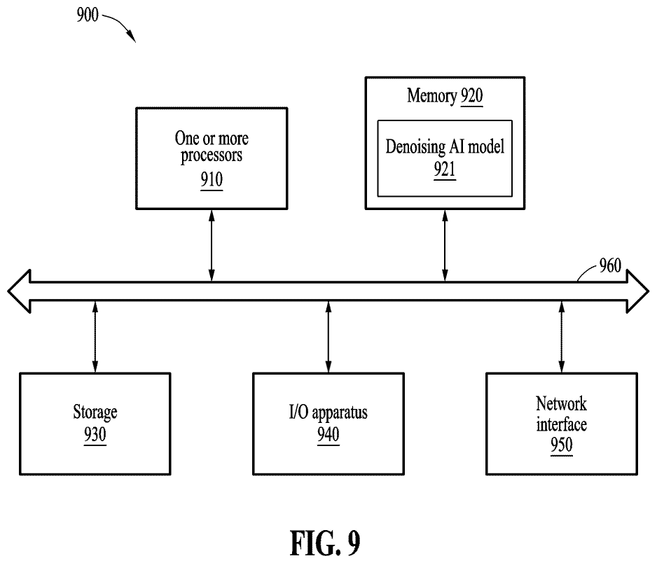

FIG. 9 is a block diagram illustrating a configuration of an electronic apparatus for performing denoising, according to an embodiment. An electronic apparatus 900 may include one or more processors 910, a memory 920, a storage 930, an input/output (I/O) apparatus 940, and a network interface 950. The one or more processors 910, the memory 920, the storage 930, the I/O apparatus 940, and the network interface 950 may communicate with one another via a communication bus 960. For example, an electronic apparatus 900 may be implemented as at least a part of a mobile device such as a mobile phone, a smartphone, a personal digital assistant (PDA), a netbook, a tablet computer or a laptop computer, a wearable device such as a smart watch, a smart band or smart glasses, a computing device such as a desktop or a server, a home appliance such as a television (TV), a smart TV or a refrigerator, a security device such as a door lock, or a vehicle such as an autonomous vehicle or a smart vehicle. The electronic apparatus 900 may structurally and/or functionally include the denoising apparatus 700 of FIG. 7 and/or the training apparatus 800 of FIG. 8.

The one or more processors 910 may execute instructions stored in the memory 920 or the storage 930. The instructions, when executed by the one or more processors 910, may cause the electronic apparatus 900 to perform the operations described above with reference to FIGS. 1 to 8. The memory 920 may include a non-transitory computer-readable storage medium or a non-transitory computer-readable storage device. The memory 920 may store instructions to be executed by the one or more processors 910 and store related information while software and/or an application is executed by the electronic apparatus 900. The memory 920 may store a denoising AI model 921 for performing denoising. In a state in which at least a portion of the denoising AI model 921 is stored in the memory 920, the operations described above with reference to FIGS. 1 to 8 may be performed by the electronic apparatus 900.

The storage 930 may include a non-transitory computer-readable storage medium or a non-transitory computer-readable storage device. For example, the storage 930 may include a magnetic hard disk, an optical disc, flash memory, a floppy disk, or any other form of non-volatile memory known in the art.

The I/O apparatus 940 may receive an input from a user in traditional input ways such as through a keyboard and a mouse, and in new ways such as through touch, voice, and an image. For example, the I/O apparatus 940 may detect an input from a keyboard, a mouse, a touchscreen, a microphone, or the user, and may include any other device configured to transfer the detected input to the electronic apparatus 900. The I/O apparatus 940 may provide the user with an output of the electronic apparatus 900 through a visual channel, an auditory channel, or a tactile channel. The I/O apparatus 940 may include, for example, a display, a touchscreen, a speaker, a vibration generator, or any other device configured to provide an output to the user. The network interface 950 may communicate with an external device via a wired or wireless network.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component and/or a combination thereof. For example, the apparatus, the method, and the components described in the embodiments may be implemented using a general-purpose or special-purpose computer, such as a processor, a controller, an arithmetic logic unit (ALU), a DSP, a microcomputer, an FPGA, a programmable logic unit (PLU), a microprocessor, or any other devices capable of responding to and executing instructions. A processing device may run an operating system (OS) and one or more software applications that run on the OS. The processing device also may access, store, manipulate, process, and generate data in response to execution of the software. For purpose of simplicity, the description of the processing device is used as singular; however, one skilled in the art will appreciate that the processing device may include multiple processing elements and multiple types of processing elements. For example, the processing device may include a plurality of processors or a single processor and a single controller. In addition, different processing configurations are possible, such as parallel processors.

The software may include a computer program, a piece of code, an instruction, or one or more combinations thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored in a non-transitory computer-readable storage medium.

The methods according to the embodiments described above may be recorded in the computer-readable storage medium including program instructions to implement various operations of the embodiments described above. The computer-readable storage medium may also include, alone or in combination with the program instructions, data files, data structures, and the like. The program instructions recorded on the medium may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as floptical disks; and hardware devices that are specifically configured to store and perform program instructions, such as ROM, RAM, flash memory, and the like. Examples of program instructions include both machine code, such as produced by a compiler, and files containing higher-level code that may be executed by the computer using an interpreter.

The hardware devices described above may be configured to act as one or more software modules in order to perform the operations of the embodiments described above, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. A method of training a diffusion-based denoising artificial intelligence (AI) model, the method comprising:
determining first training data and clean data of a training data set;
estimating noise data by inputting, to the denoising AI model, the training data set and a first sampling level indicating a number of sampling steps to be applied to the first training data;
based on a difference between first ground truth data and the noise data, determining a loss value, wherein the first ground truth data corresponds to a difference between the first training data and the clean data; and
based on the loss value, training the denoising AI model.

2. The method of claim 1, wherein the sampling steps correspond to a time step at which the denoising AI model performs denoising on data once.

3. The method of claim 1, wherein the first training data comprises non-Gaussian noise.

4. The method of claim 1, wherein
the estimating of the noise data comprises:
generating Gaussian noisy data contaminated with Gaussian noise by applying one or more diffusion steps to the clean data;
generating second training data by combining the first training data with the Gaussian noisy data; and
estimating the noise data comprised in the second training data, and
the determining of the loss value comprises, based on the difference between the first ground truth data and the noise data, determining the loss value, wherein the first ground truth data corresponds to a combination of the difference between the first training data and the clean data and a difference between the Gaussian noisy data and the clean data.

5. The method of claim 4, wherein the estimating of the noise data further comprises determining a second sampling level corresponding to the second training data.

6. The method of claim 1, wherein the first sampling level is determined based on the first training data and the clean data.

7. The method of claim 1, wherein the determining of the first training data and the clean data comprises:
receiving original data;
determining target component data and target noise component data by performing data classification on the original data; and
determining the target component data as the clean data and determining, as the first training data, a combination of the target noise component data and the target component data.

8. A denoising method comprising:
training a diffusion-based denoising artificial intelligence (AI) model;
receiving first data and a first signal-to-noise ratio (SNR) value of the first data;
based on the first SNR value, determining a first sampling level indicating a number of sampling steps to be applied to the first data; and
generating first restored data by inputting, to the trained denoising AI model, the first data and the first sampling level, and
wherein the training of the denoising AI model comprises:
determining first training data and clean data of a training data set;
estimating noise data by inputting, to the denoising AI model, the training data set and a second sampling level indicating a number of sampling steps to be applied to the first training data;
based on a difference between first ground truth data and the noise data, determining a loss value, wherein the first ground truth data corresponds to a difference between the first training data and the clean data; and
based on the loss value, training the denoising AI model.

9. The denoising method of claim 8, wherein the first training data comprises non-Gaussian noise.

10. The denoising method of claim 8, wherein
the estimating of the noise data comprises:
generating Gaussian noisy data contaminated with Gaussian noise by applying one or more diffusion steps to the clean data;
generating second training data by combining the first training data with the Gaussian noisy data; and
estimating the noise data comprised in the second training data, and
the determining of the loss value comprises, based on the difference between the first ground truth data and the noise data, determining the loss value, wherein the ground truth data corresponds to a combination of the difference between the first training data and the clean data and a difference between the Gaussian noisy data and the clean data.

11. The denoising method of claim 10, wherein the estimating of the noise data further comprises determining a third sampling level corresponding to the second training data.

12. The denoising method of claim 8, wherein the second sampling level is determined based on the first raining data and the clean data.

13. The denoising method of claim 8, wherein the determining of the first training data and the clean data comprises:
receiving original data;
determining target component data and target noise component data by performing data classification on the original data; and
determining the target component data as the clean data and determining, as the first training data, a combination of the target noise component data and the target component data.

14. An apparatus for training a diffusion-based denoising artificial intelligence (AI) model, the apparatus comprising:
one or more processors; and
a memory comprising instructions executable by the one or more processors,
wherein the instructions, when executed by the one or more processors, cause the apparatus to:
determine first training data and clean data of a training data set;
estimate noise data by inputting, to the denoising AI model, the training data set and a first sampling level indicating a number of sampling steps to be applied to the first training data;
based on a difference between first ground truth data and the noise data, determine a loss value, wherein the first ground truth data corresponds to a difference between the first training data and the clean data; and
based on the loss value, train the denoising AI model.

15. The apparatus of claim 14, wherein the sampling steps correspond to a time step at which the denoising AI model performs denoising on data once.

16. The apparatus of claim 14, wherein the first training data comprises non-Gaussian noise.

17. The apparatus of claim 14, wherein the instructions, when executed by the one or more processors, cause the apparatus to:
generate Gaussian noisy data contaminated with Gaussian noise by applying one or more diffusion steps to the clean data in order to estimate the noise data;
generate second training data by combining the first training data with the Gaussian noisy data;
estimate the noise data comprised in the second training data;
in order to determine the loss value, based on the difference between the first ground truth data and the noise data, determine the loss value, wherein the first ground truth data corresponds to a combination of the difference between the first training data and the clean data and a difference between the Gaussian noisy data and the clean data.

18. The apparatus of claim 17, wherein the instructions, when executed by the one or more processors, cause the apparatus to, in order to estimate the noise data, determine a second sampling level corresponding to the second training data.

19. The apparatus of claim 14, wherein the first sampling level is determined based on the first training data and the clean data.

20. The apparatus of claim 14, wherein the instructions, when executed by the one or more processors, cause the apparatus to, in order to determine the first training data and the clean data:
receive original data;
determine target component data and target noise component data by performing data classification on the original data; and
determine the target component data as the clean data and determine, as the first training data, a combination of the target noise component data and the target component data.
